(19) United States
(12) Patent Application Publication
(10) Pub. No.: US 2022/0165029 A1
(43) Pub. Date: May 26, 2022

(54) Computer Vision Systems and Methods for High-Fidelity Representation of Complex 3D Surfaces Using Deep Unsigned Distance Embeddings

(71) Applicant: Insurance Services Office, Inc., Jersey City, NJ (US)

(72) Inventors: Rahul M. Venkatesh, Bangalore (IN); Sarthak Sharma, Delhi (IN); Aurobrata Ghosh, Pondicherry (IN); Laszlo A. Jeni, Budapest (HU); Maneesh Kumar Singh, Princeton, NJ (US)

(73) Assignee: Insurance Services Office, Inc., Jersey City, NJ (US)

(21) Appl. No.: 17/534,849

(22) Filed: Nov. 24, 2021

Related U.S. Application Data
(60) Provisional application No. 63/118,083, filed on Nov. 25, 2020.

(51) Int. Cl. G06T 17/20; G06T 7/70; G06T 3/40; G06K 9/62; G06T 15/06

(52) U.S. Cl. CPC G06T 17/20; G06T 7/70; G06T 3/40; G06T 2207/20081; G06T 15/06; G06T 2207/10028; G06K 9/6257

(57) ABSTRACT

Computer vision systems and methods for high-fidelity representation of complex 3D surfaces using deep unsigned distance embeddings are provided. The system receives data associated with the 3D surface. The system processes the data based at least in part on one or more computer vision models to predict an unsigned distance field and a normal vector field. The unsigned distance field is indicative of proximity to the 3D surface and includes a predicted closest unsigned distance to a surface point of the 3D surface from a given point in a 3D space. The normal vector field is indicative of a surface orientation of the 3D surface and includes a predicted normal vector to the surface point closest to the given point. The system further determines the 3D surface representation based at least in part on the unsigned distance field and the normal vector field.

### RELATED APPLICATIONS

This application claims priority to U.S. Provisional Patent Application Ser. No. 63/118,083 filed on Nov. 25, 2020, the entire disclosure of which is hereby expressly incorporated by reference.

### BACKGROUND

### Technical Field

The present disclosure relates generally to the field of computer vision. More specifically, the present disclosure relates to computer vision systems and methods for high-fidelity representation of complex three-dimensional (3D) surfaces using deep unsigned distance embeddings.

### Related Art

High fidelity representation of potentially open 3D surfaces with complex topologies is important for reconstruction of 3D structures from images, point clouds, and other raw sensory data, fusion of representations from multiple sources, and for rendering of such surfaces for many applications in computer vision, computer graphics, and the animation industry. Due to the limited resolution of complex and arbitrary topologies, classical discrete shape representations using point clouds, voxels, and meshes produce low quality results when used in the above applications. In addition, the resolution of such reconstructions is limited by the predefined number of vertices in the network.

Further, several implicit 3D shape representation approaches have been proposed to improve both the quality of representations and the impact on downstream applications. However, these methods can only be used to represent topologically closed shapes which greatly limits the class of shapes that they can represent, and they are unable to model surfaces that are open or noisy input data containing holes in the surfaces. As a consequence, they also often need clean, watertight meshes for training. For example, approaches using the Signed Distance Function (SDF F) as the implicit function from (pᵢ, F (pᵢ)) samples where the SDF F (pᵢ) is positive (negative) for points pᵢ inside (outside) the surface. This requires that the ground truth surface be watertight (closed). Since the most 3D shape datasets do not have watertight shapes, preprocessing is needed to create watertight meshes, which can result in loss of surface fidelity.

Other methods have been attempted, such as machine learning of implicit surface representations directly from raw unoriented point clouds. However, such methods also make an assumption that the underlying surface represented by the point cloud is closed, leading to learned representations necessarily describing closed shapes. Even in cases where the raw input point cloud is scanned from an open surface, learned representations tend to incorrectly close the surface. Since existing approaches assume that the 3D shaped to be modeled are closed, they suffer from a loss of fidelity when modeling open shapes or learning from noisy meshes.

Accordingly, what would be desirable are computer vision systems and methods for high-fidelity representation of complex 3D surfaces using deep unsigned distance embeddings, which address the foregoing, and other, needs.

### SUMMARY

The present disclosure relates to computer vision systems and methods for high-fidelity representation of complex three-dimensional (3D) surfaces using deep unsigned distance embeddings. The system receives data associated with a 3D surface. The system processes the data based at least in part on one or more computer vision models (e.g., deep neural networks) to predict an unsigned distance field and a normal vector field. The unsigned distance field is indicative of proximity to the 3D surface and includes a predicted closest unsigned distance to a surface point of the 3D surface from a given point in a 3D space. The normal vector field is indicative of a surface orientation of the 3D surface and includes a predicted normal vector to the surface point closest to the given point. The system further determines the 3D surface representation based at least in part on the unsigned distance field and the normal vector field.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a table illustrating performance of the system of the present disclosure;

FIG. 3 is a flowchart illustrating overall processing steps carried out by the system of the present disclosure;

FIG. 4 is graph representing non-differentiability of a uDF on a surface of a shape;

FIG. 5 is a flowchart illustrating training processing steps carried out by the system of the present disclosure;

FIG. 6 is graph illustrating a surface normal and a modulo 180° of the surface normal used by the system of the present disclosure;

FIG. 7 illustrates a visualization of uDF and nVF and a model architecture used for training the system of the present disclosure;

FIG. 8 is a flowchart illustrating the step 58A of FIG. 3 in greater detail;

FIG. 9 illustrates a multi-resolution iso-surface extraction for uDFs performed by the system of the present disclosure;

FIG. 10 is a flowchart illustrating the step 58B of FIG. 3 in greater detail;

FIG. 11 is a graph showing a sphere tracing procedure and a graph leveraging nVF for obtaining more accurate ray-scene intersections performed by the system of the present disclosure;

FIG. 12 illustrates implicit 3D shape representations learned on three shapes using the deep unsigned distance embedding (DUDE);

FIG. 13 illustrates a ray casting using normals obtained by differentiating uDF and a ray casting using surface normals estimated by the nVF of the present disclosure;

FIG. 14 is table of depth error, normal error, and silhouette IOU metrics;

FIG. 15 illustrates absolute depth error between a ground truth depth map and depth maps estimated using sphere tracing;

FIG. 16 illustrates results of surface reconstruction from point clouds; and

FIG. 17 is a diagram illustrating hardware and software components capable of being utilized to implement the system of the present disclosure.

### DETAILED DESCRIPTION

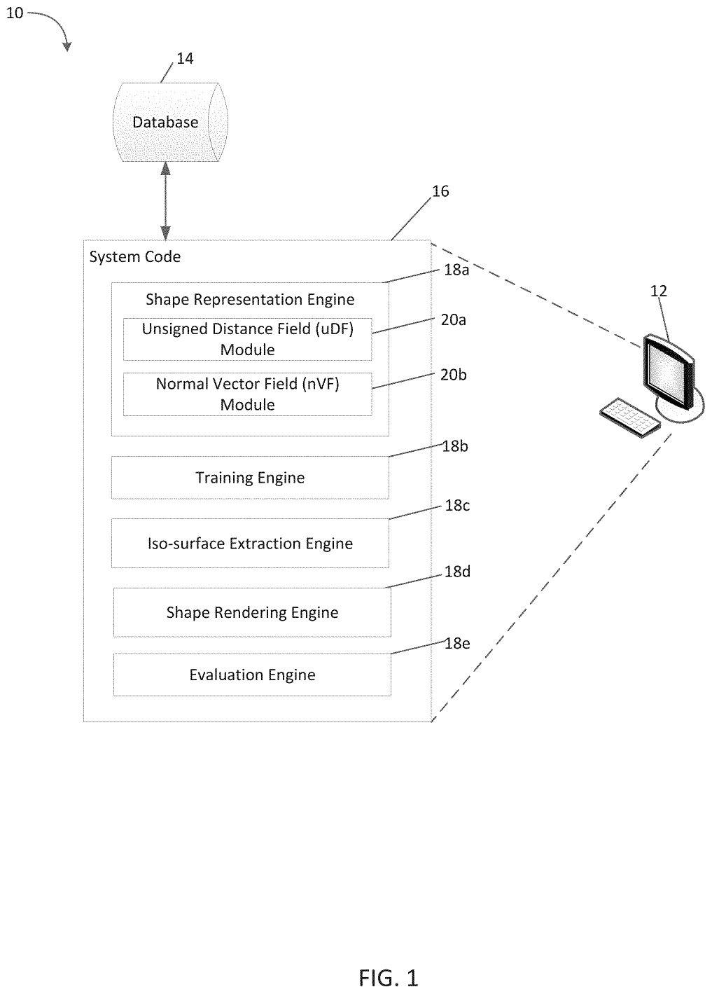

The present disclosure relates to computer vision systems and methods for high-fidelity representation of complex 3D surfaces using deep unsigned distance embeddings, as described in detail below in connection with FIGS. 1-17.

The computer vision systems and methods disclosed herein provide a disentangled shape representation that utilizes an unsigned distance field (uDF) to represent proximity to a surface, and a normal vector field (nVF) to represent surface orientation. The systems and methods disclosed herein are also referred to as “deep unsigned distance embedding” (DUDE) systems and methods. A combination of these two fields (uDF+nVF) can be used to learn high fidelity representations for arbitrary open and closed shapes. The shape representations disclosed herein can be directly learned from noisy triangle “soups,” and do not need watertight meshes. Additionally, the DUDE systems and methods further provide novel extracting and rendering of iso-surfaces from the learned representations. The DUDE systems and methods were validated on benchmark 3D datasets and it was demonstrated that they produce significant improvements over the state of the art.

Turning to the drawings, FIG. 1 is a diagram illustrating an embodiment of the system 10 of the present disclosure. The system 10 can be embodied as a central processing unit 12 (processor) in communication with a database 14. The processor 12 can include, but is not limited to, a computer system, a server, a personal computer, a cloud computing device, a smart phone, or any other suitable device programmed to carry out the processes disclosed herein. The system 10 can retrieve data from the database 14 associated with one or more 3D objects. Still further, the system 10 can be embodied as a customized hardware component such as a field-programmable gate array (“FPGA”), an application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

The database 14 stores 3D data associated with objects with arbitrary topologies, such as point clouds, triangle soups having multiple triangles, mesh data, 3D scan files, 3D data associated with open shapes, 3D data associated with closed shapes, or the like. Additionally and/or alternatively, the database 14 can store digital images and/or digital image datasets of the objects, and one or more outputs from various components of the system 10 (e.g., outputs from a shape representation engine 18a, an unsigned distance field (uDF) module 20a, a normal vector field (nVF) module 20b, a training engine 18b, an iso-surface extraction engine 18c, a shape rendering engine 18d, an evaluation engine 18e, and/or other components of the system 10), one or more untrained and trained computer vision models for 3D surface and/or shape representation, and associated training data. The system 10 can retrieve the 3D data, the digital images, and/or the digital image datasets from the database 14 and process such data for 3D surface and/or 3D shape representations. As such, by the terms “imagery” and “image” as used herein, it is meant not only 3D imagery and computer-generated imagery, including, but not limited to, triangle soups, point clouds, 3D images, mesh data, open shape data, closed shape data, 3D scan data, etc., but also two-dimensional (2D) data, optical imagery (including scanner and/or camera imagery), or the like.

The system 10 includes system code 16 (non-transitory, computer-readable instructions) stored on a computer-readable medium and executable by the hardware processor 12 or one or more computer systems. The system code 16 can include various custom-written software modules that carry out the steps/processes discussed herein, and can include, but is not limited to, the shape representation engine 18a, the unsigned distance field (uDF) module 20a, the normal vector field (nVF) module 20b, the training engine 18b, the iso-surface extraction engine 18c, the shape rendering engine 18d, and the evaluation engine 18e. The system code 16 can be programmed using any suitable programming languages including, but not limited to, C, C++,C #, Java, Python, or any other suitable language. Additionally, the system code 16 can be distributed across multiple computer systems in communication with each other over a communications network, and/or stored and executed on a cloud computing platform and remotely accessed by a computer system in communication with the cloud platform. The system code 16 can communicate with the database 14, which can be stored on the same computer system as the code 16, or on one or more other computer systems in communication with the code 16.

The system 10 can accurately model both open and closed shapes with high fidelity, arbitrary, and complex topologies. The system 10 can further learn from noisy meshes (e.g., learning directly from raw scan data stored in the form of raw triangle soups). In some embodiments, the system 10 can also learn from watertight meshes.

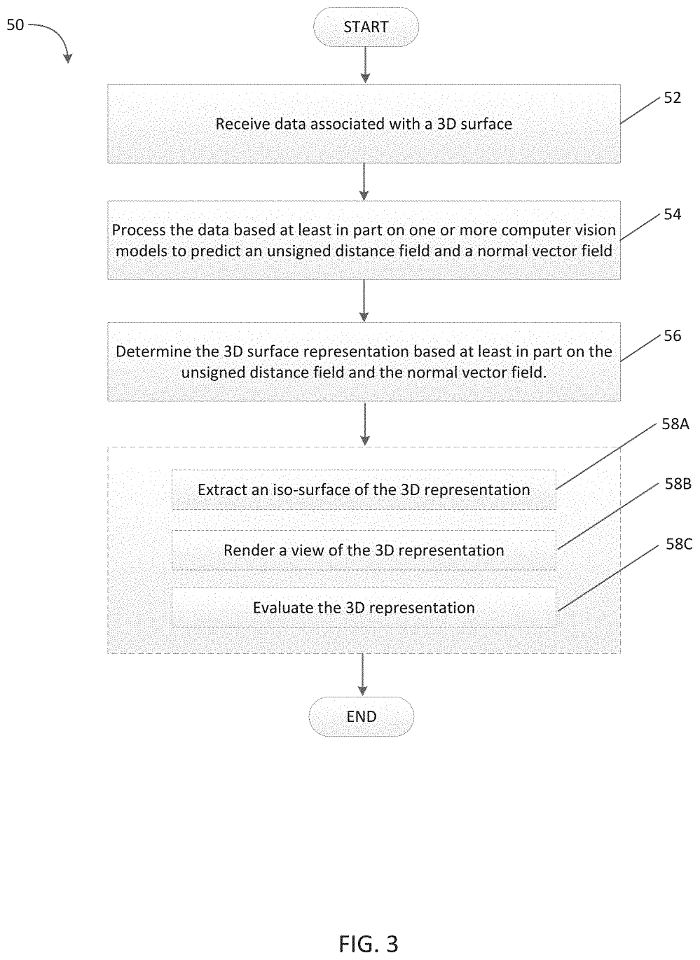

The uDF module 20a can include unsigned distance functions that are unambiguously defined for both open and closed shapes. An open shape can be a shape or figure whose line segments, shapes, and/or curves do not meet. For example, open shapes can have one or more gaps in between. A closed shape can be a shape having no openings or gaps. Closed shapes can partition the 3D space into interior and exterior regions. In contrast to the unsigned distance functions, signed distance functions are only defined for closed shapes in existing and conventional technologies. Examples of the uDFs are described in FIGS. 3, 4, and 7.

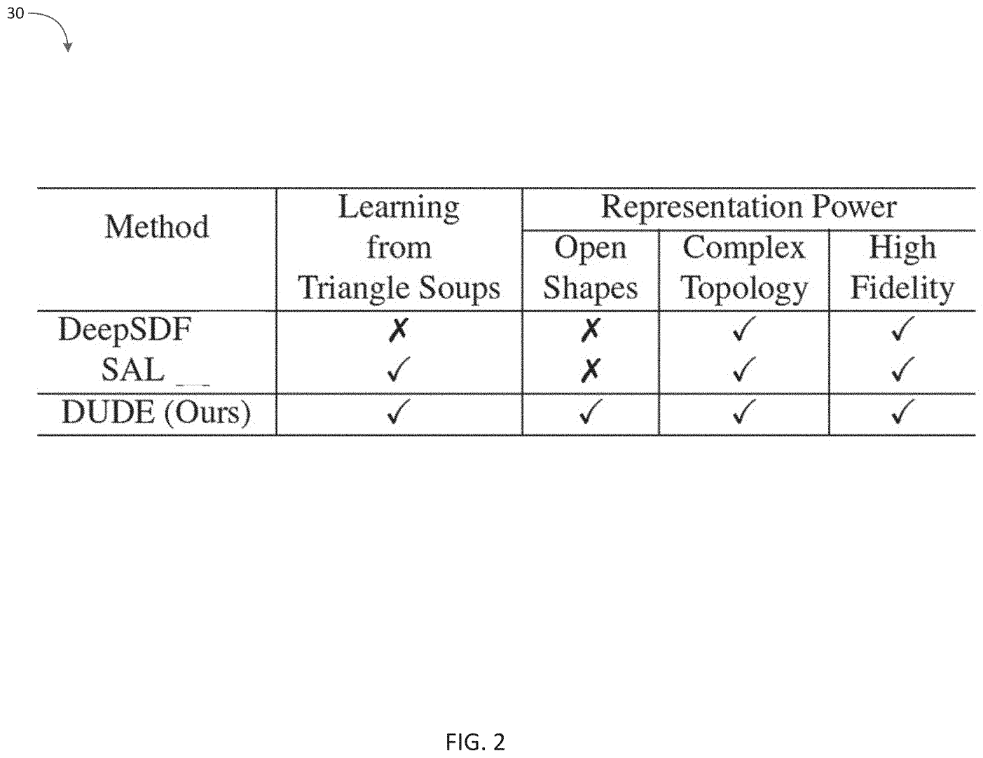

The nVF module 20b can generate nVFs using one or more computer vision models (e.g., deep neural networks) that generates normals to the learned surface. The nVFs can compensate non-differentiability of the uDF on the surface, which makes easy availability of surface normals, such as extraction of surface normals, rendering using ray tracing, and optimizing for downstream tasks like shape retrieval. The system 10 can decompose an implicit shape representation into two parts: (1) a uDF, and, (2) an nVF. An implicit shape representation can refer to a shape representation using an implicit function that is not solved for independent variable or variables, which is opposed to an explicit shape representation (e.g., representations based on voxels, point clouds, polygonal meshes, or the like) that refers to a shape representation using an explicit function that is solved for independent variable or variables. A combination of the uDF and nVF can be capable of accurately representing any arbitrary shape with complex topology, irrespective of whether it is open/closed (in contrast to existing implicit shape representations as further described in FIG. 2). Examples of the nVFs are described in FIGS. 3, 6, and 7.

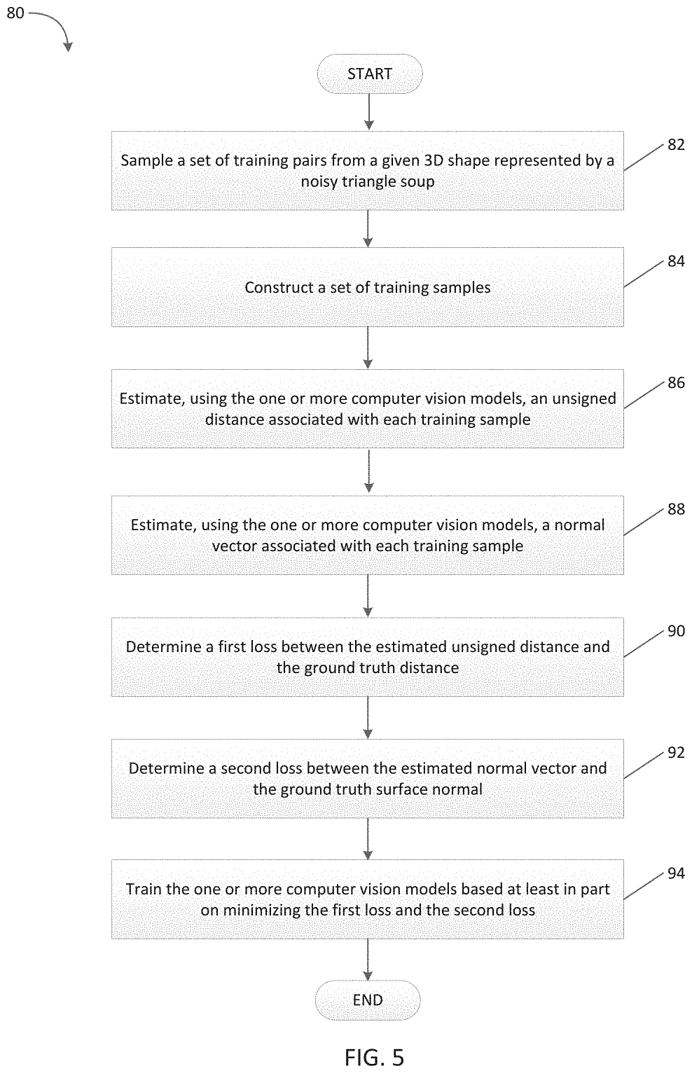

The training engine 18b can provide a robust loss function to train the nVF to learn directly from noisy triangle soups with oriented normals, while the nVF produces a continuous normal vector field modeling normals to an unoriented surface. For example, the training engine 18b can take the modulo 180° of normals into account to reduce errors between nVF and the oriented normals. Examples of the robust loss function are described in FIGS. 5-7.

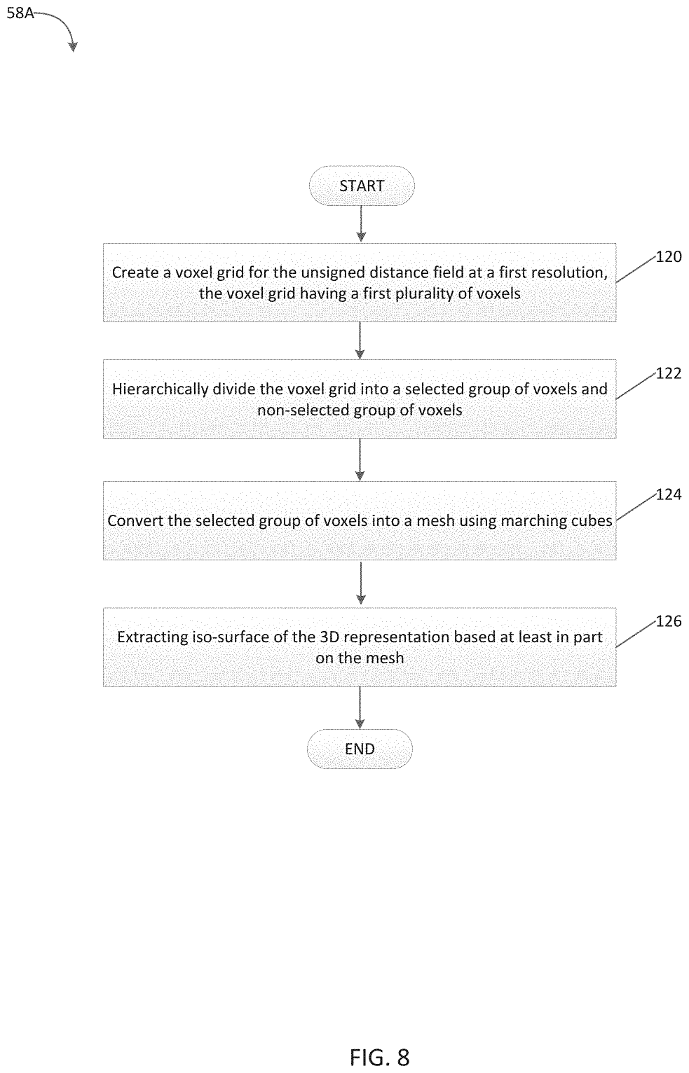

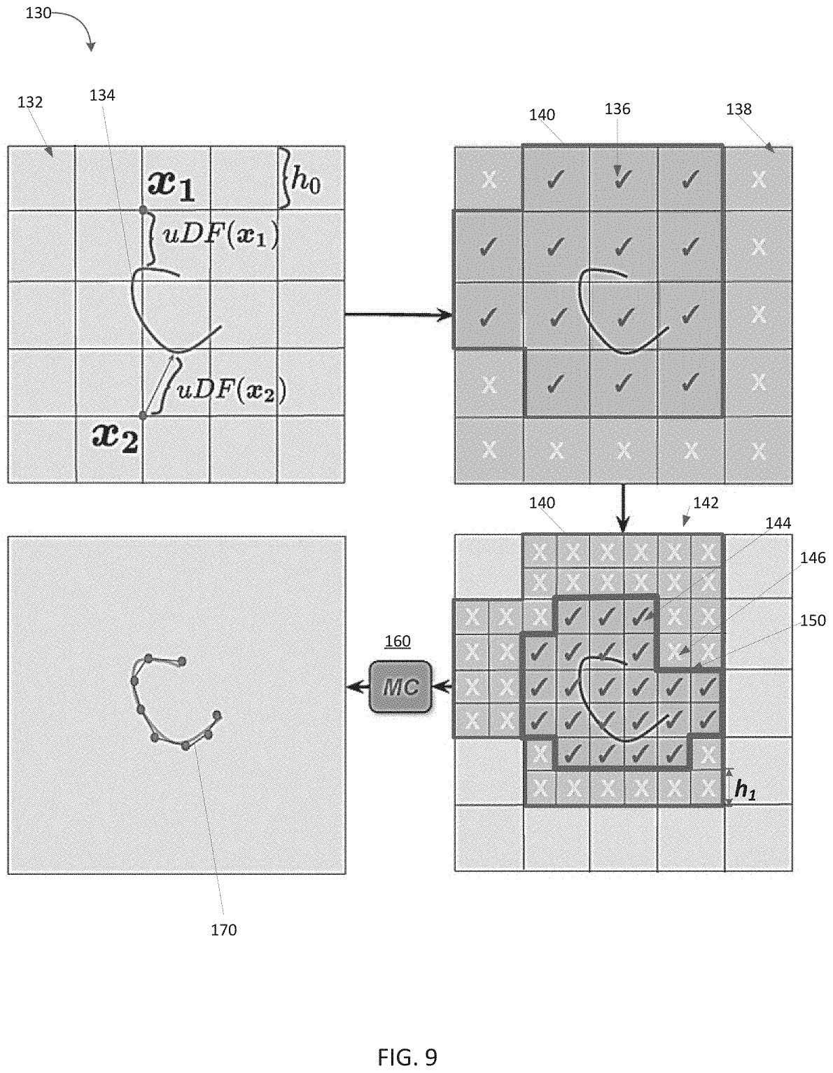

The iso-surface extraction engine 18c provides an efficient method to perform multi-resolution iso-surface extraction from uDFs. For example, after the implicit surface representation is learned, the iso-surface extraction engine 18d can convert the uDFs into meshes so that an explicit representation of the surface can be extracted, as further described in FIGS. 8 and 9.

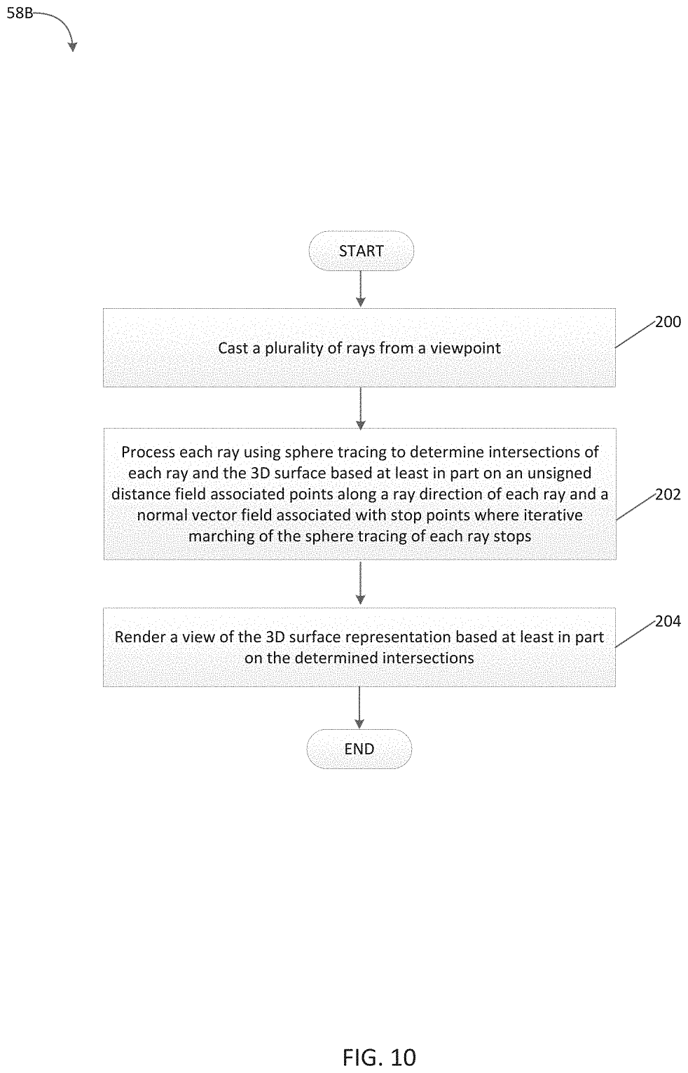

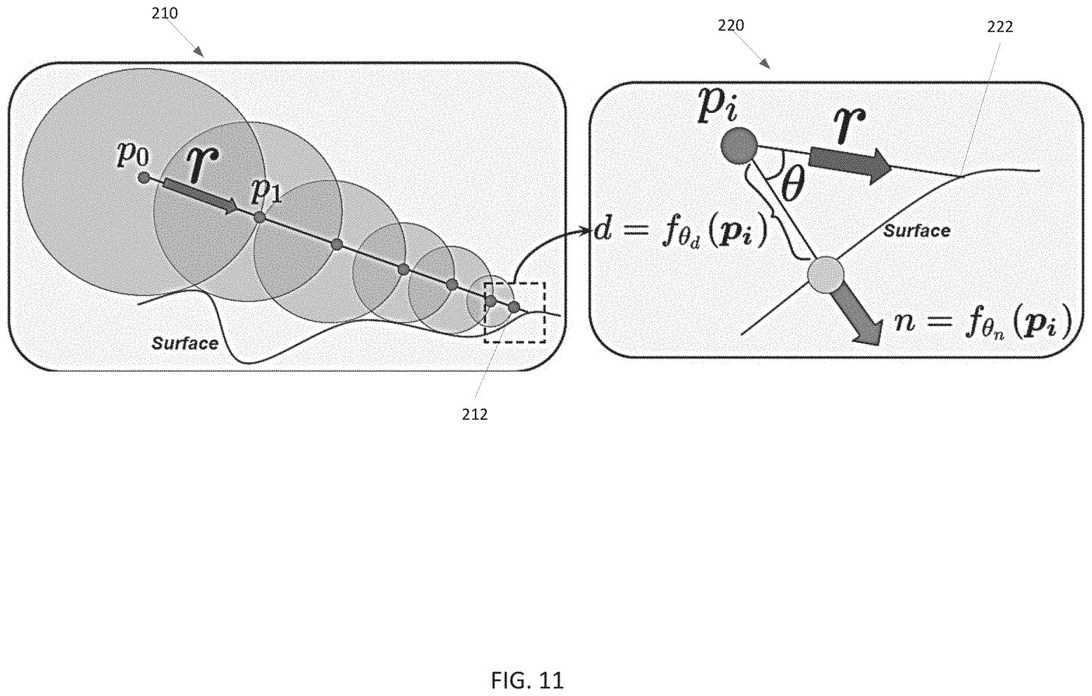

The shape rendering engine 18d carries out a novel sphere tracing method that utilizes the learned nVF to enable more accurate ray-scene intersection, which can be applied to uDFs. The existing sphere tracing methods can be only applied to signed distance functions which allow for computation of ray-scene intersections using a bisection search close to the surface. However, the existing sphere tracing methods cannot be applied to uDFs due to the fact that the uDFs do not change sign on crossing the surface. The shape rendering engine 18b utilizes the uDFs to get close to the surface and then utilizes the learned nVF close to the surface for accurate ray-scene intersections, as further described in FIGS. 10 and 11.

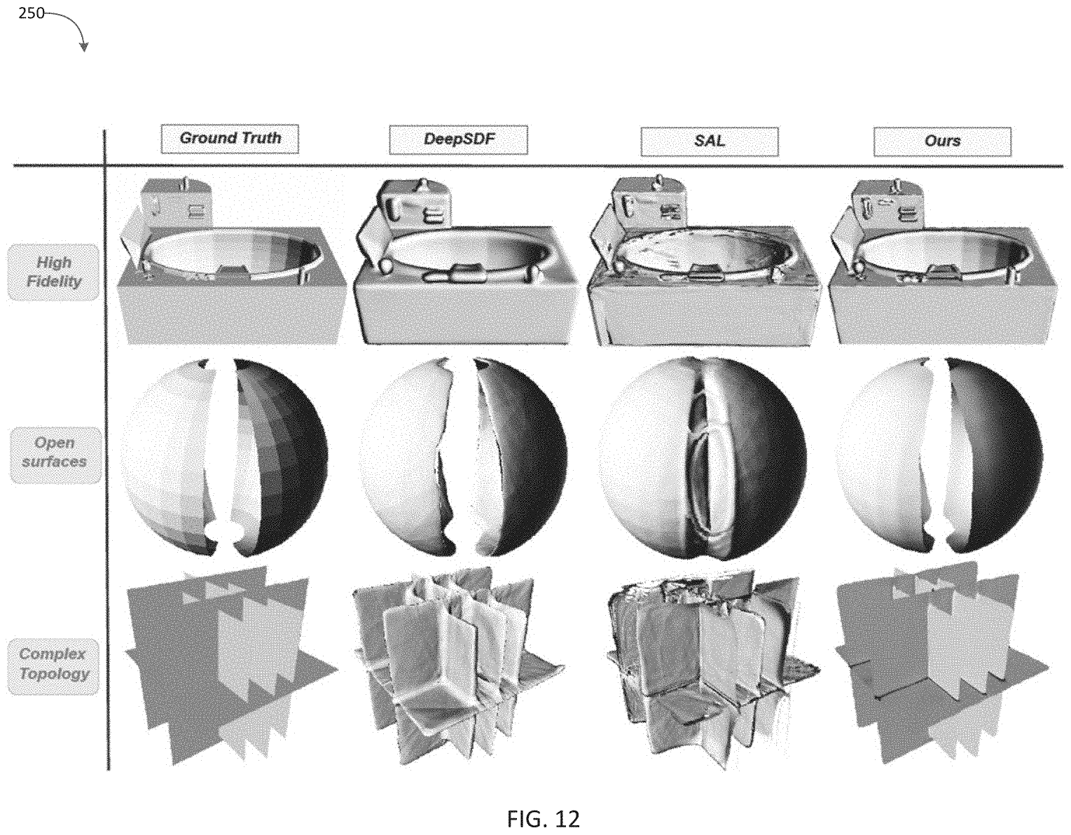

FIG. 2 is a table 30 comparing the system 10 (also referred to as DUDE) with prior art systems such as the deep signed distance function (DeepSDF) and sign agnostic learning (SAL) systems. As shown in FIG. 2, the DeepSDF system cannot work with raw triangle soups, and both the DeepSDF and the SAL systems cannot represent open shapes. In contrast, the system 10 can learn high fidelity representations of open (and closed) shapes with complex topologies, directly from raw triangle soups. A detailed evaluation about this comparison is described in FIGS. 12-16.

FIG. 3 is a flowchart illustrating overall processing steps 50 carried out by the system 10 of the present disclosure. Beginning in step 52, the system 10 receives data associated with a 3D surface. The data can include a 2D or 3D representation of one or more objects, one or more open shapes with arbitrary topology, a triangle soup having a plurality of triangles, and/or or a plurality of point clouds. The system 10 can obtain the data from the database 14. Additionally and/or alternatively, the system 10 can instruct a shape capture device (e.g., a 3D scanner, a digital camera, a LiDAR device, or the like) to capture the data. In some embodiments, the system 10 can include the shape capture device. Alternatively, the system 10 can communicate with a remote shape capture device. It should be understood that the system 10 can perform the aforementioned task via the shape representation engine 18a. Still further, it is noted that the system 10, in step 52, can receive and process imagery and/or data provided to the system 10 by an external and/or third-party computer system.

In step 54, the system 10 processes the data based at least in part on one or more computer vision models to predict an unsigned distance field and a normal vector field. The one or more computer vision models can include one or more deep neural networks (DNN). The unsigned distance field (uDF) can be indicative of proximity to the 3D surface. The normal vector field (nVF) can be indicative of a surface orientation of the 3D surface. The uDF can include a predicted closest unsigned distance to a surface point of the 3D surface from a given point in a 3D space, and the nVF comprises a predicted normal vector to the surface point closest to the given point.

In some embodiments, an unsigned distance function outputs the uDF having the closest unsigned distance to the 3D surface from any given point in a 3D space. The system 10 models a 3D shape using the uDF which can represent both watertight and non-watertight shapes.

uDF(x)=d:x∈ [symbol] ³, d∈ [symbol] ⁺ Equation (1)

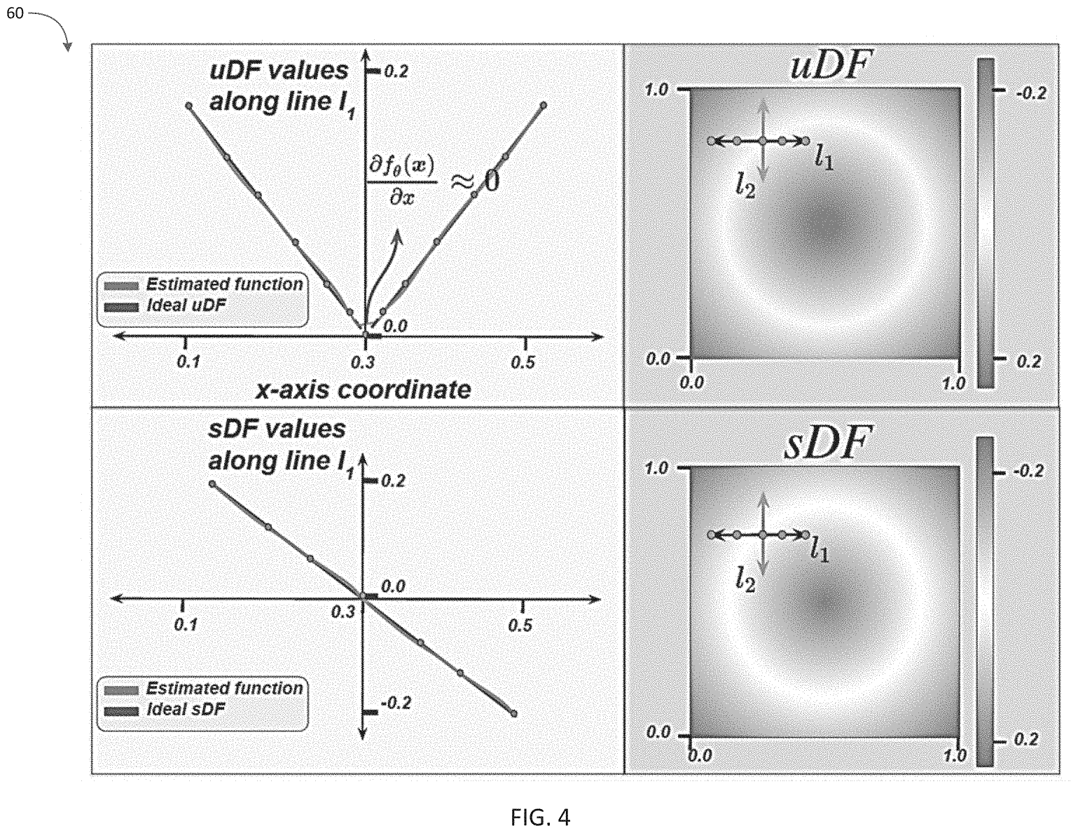

As can be seen from Equation (1), the unsigned distance function can convert x in a 3D space [symbol] ³ into d in a space of positive real numbers [symbol] ³⁰. Compared with a signed distance field (sDF), the uDF is nondifferentiable at the surface. For example, as can be seen in FIG. 4 (which is graph 60 representing non-differentiability of a uDF on a surface of a shape), on the left of the graph 60, uDF values are sampled along line l₁ for both an estimated unsigned distance function and an ideal unsigned distance function. Similarly, sDF values are sampled along line l₁ for both an estimated signed distance function and an ideal signed distance function. The uDF is differentiable except at the surface (e.g., the point (0, 0)). On the right of the graph 60, the uDF and sDF with sampled points on line l₁ are visualized. To make the uDF differentiable, the system 10 can sample training data points slightly away from the surface. Since estimation of high quality surface normals is important for several downstream tasks, the system 10 extract the surface normal using the nVF to compensate the non-differentiability of the uDF. For any 3D location, x, a nVF represents the nVF normal to the surface point closest to x. Formally,

nVF(x)=v:x∈ [symbol] ³, v∈ [symbol] ³,

v=n(\tilde{x}):\tilde{x}=x+rₓ*uDF(x) Equation (2)

where rₓ is a unit vector from the point x to its closest point on the surface, i.e. \tilde{x}. In some embodiments, n(x) is the normal to the surface at the point x.

In step 56, the system 10 determines the 3D surface representation based at least in part on the uDF and the nVF. For example, the 3D surface can be represented by the uDF and the nVF as described below.

In some embodiments, the system 10 can model the uDF+nVF pair using multilayer perceptron modes (MLPs) to train using a noisy triangle soup or a noisy representation of the underlying ground truth surface, as further described in FIG. 5, which is a flowchart illustrating training processing steps 80 carried out by the system 10 of the present disclosure. As shown in FIG. 5, beginning in step 82, the system 10 samples a set of training pairs from a given 3D shape represented by a noisy triangle soup. Each training pair includes a sampling surface point on a triangle face and a surface normal from the sampling surface point.

For example, given a 3D shape represented by the noisy triangle soup, the system 10 can construct training samples, [symbol] , which contain a point, x, the uDF and the nVF evaluated at x

[symbol]

={(x,d,v):d=uDF(x), v=nVF(x)} Equation (3)

using the following procedure: the system 10 first densely samples a set of {points, surface normal} pairs from the triangle soup, by uniformly sampling points on each triangle face. The set of pairs can be represented by points X={(xₛ, vₛ)}. Since each point is sampled from a triangle face, the normal to the triangle face provides the associated surface normal for that point.

In step 84, the system 10 constructs a set of training samples. Each training sample includes a sampling point in the 3D space, a ground truth distance, and a ground truth surface normal. The ground truth distance is a distance between the sampling point and a nearest corresponding surface point in a training pair of the set of training pairs, and the ground truth surface normal is a surface normal from the training pair. For example, given this set X, the set [symbol] is constructed by sampling points x in the 3D space and finding the nearest corresponding point in X to construct the training sample (x, ∥xₛ−x∥₂, vₛ).

In step 86, the system 10 estimates, using the one or more computer vision models, an unsigned distance associated with each training sample. In step 88, the system 10 estimates, using the one or more computer vision models, a normal vector associated with each training sample. For example, the set [symbol] is used train the DNNs to approximate the uDF and the nVF. More concretely, the system 10 trains the DNN f_{θ}_{_{d}} to approximate uDF, and DNN f_{θ}_{ₙ}, to approximate nVF.

In step 90, the system 10 determines a first loss between the estimated unsigned distance and the ground truth distance. For example, the system 10 uses a first loss function to train f_{θ}_{_{d}} by a L2 loss between the estimated unsigned distance, f_{θ}_{_{d}}(x) and the ground truth distance, d=∥xₛ−x∥₂,

[symbol]

_{uDF=}∥f_{θ}_{_{d}}(x)−d∥₂, Equation (4)

In step 92, the system 10 determines a second loss between the estimated normal vector and the ground truth surface normal. In some embodiments, the ground truth surface normal includes the first ground truth surface normal and the second surface normal. The second loss is selected from a loss between the estimated normal vector and a first ground truth surface normal and a loss between the estimated normal vector and a second ground truth surface normal. The second ground truth surface normal is indicative of a modulo 1800 of the first ground truth surface normal.

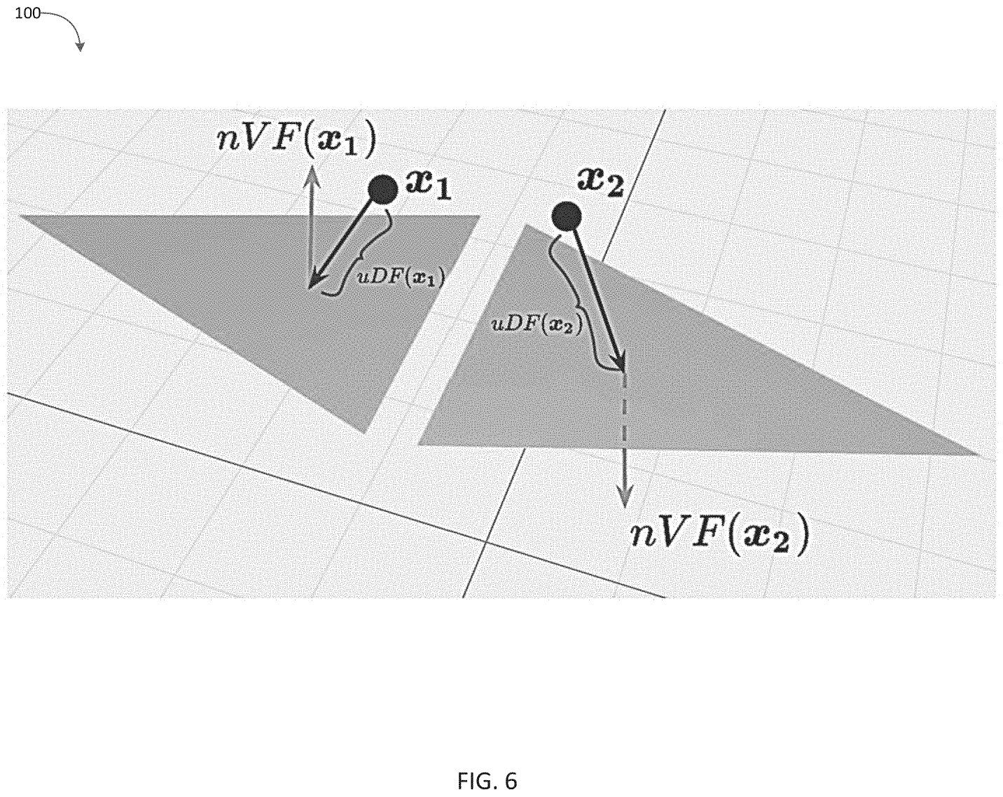

For example, uDFs naturally correspond to unoriented surfaces (which are also logically necessitated by open surfaces). However, for most ray-casting applications this is not an issue as the direction of the first intersected surface can be chosen based on the direction of the ray. So, the ambiguity of n or −n can be handled. This implies a modulo 180° representation in the DNN suffices. However, such a representation needs to be learned from a noisy triangle soup with oriented surface normals with possible directional incoherence (in the modulo 180° sense) between adjacent triangles. For example, as shown in FIG. 6 (which is graph 100 illustrating a surface normal and a modulo 180° of the surface normal used by the system 10 of the present disclosure), for a triangle soup, adjacent faces can have oppositely facing normals (e.g., in the modulo 180° sense).

To allow for this, the system 10 optimizes the minimum of the two possible losses, computed from each n or −n. More concretely,

[symbol]

_{nVF}⁽¹⁾=∥f_{θ}_{ₙ}(x)−vₛ∥₂,

[symbol]

_{nVF}⁽²⁾=∥f_{θ}_{ₙ}(x)−(−vₛ)∥₂,

[symbol]

_{nVF}=min( [symbol] _{nVF}⁽¹⁾, [symbol] _{nVF}⁽²⁾). Equation (5)

This allows for the network to learn surface normals modulo 180°. The incoherence in the noisy triangle soup is handled by the continuity property of the DNNs and, practically, coherent normal fields are learned.

In step 94, the system 10 trains the one or more computer vision models based at least in part on minimizing the first loss and the second loss. For example, the system 10 trains the DNNs based at least in part on minimizing [symbol] _{uDF} (e.g., shown Equation (4)) and [symbol] _{nVF} (e.g., shown Equation (5)). After training, the zero-level set of f_{θ}_{_{d}}, which approximates the uDF, represents points on the surface, while f_{θ}_{ₙ}, approximating nVF, represents the surface normals of the corresponding points on this level set.

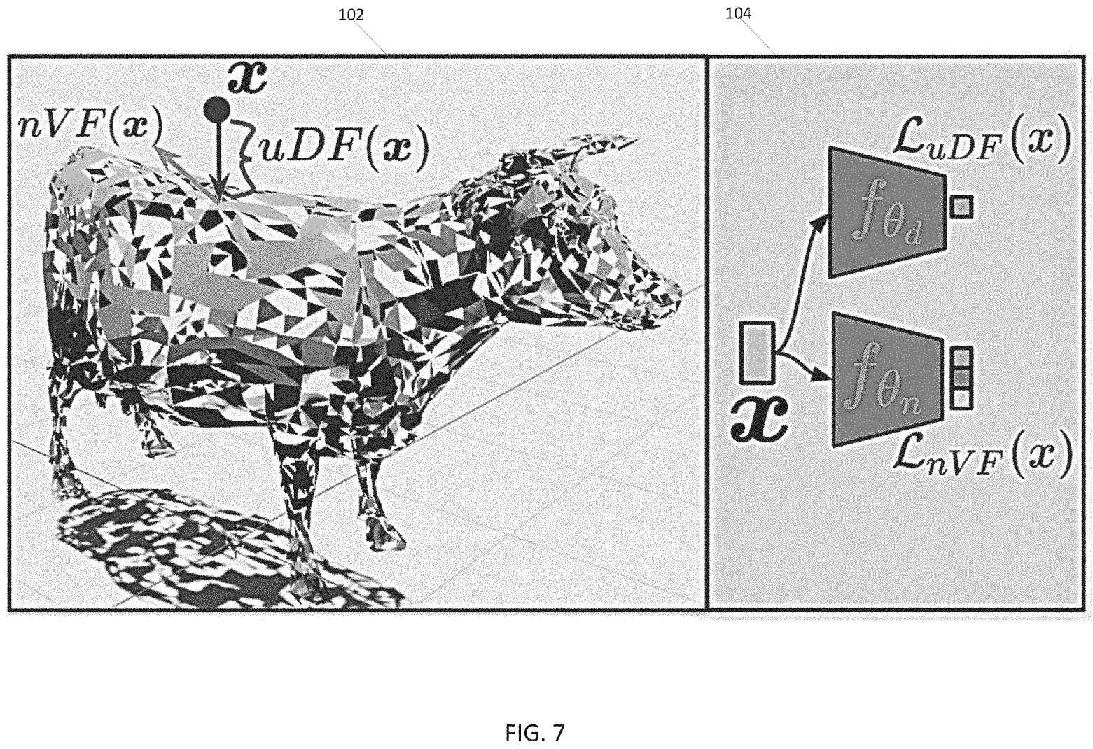

As can be seen in FIG. 7 (which illustrates a visualization 102 of uDF and nVF and a model architecture 104 used for training the system 10 of the present disclosure), the visualization 102 illustrates that the uDF(x) represents the closest unsigned distance to a surface point of the 3D surface of a modeled cow from a given point x in a 3D space. The give point x is slightly away from the 3D surface. The nVF(x) represents a normal to the surface point closest to the give point x. The model architecture 104 inputs the give point x into a DNN f_{θ}_{_{d}} to approximate the uDF(x) and inputs the give point x into a DNN f_{θ}_{ₙ} to approximate the uVF(x) by minimizing loss functions [symbol] _{uDF}(x) and [symbol] _{nVF} (x).

Referring back to FIG. 3, in some embodiments, in optional step 58A, the system 10 extracts an iso-surface of the 3D representation. For example, FIG. 8 is a flowchart illustrating the step 58A of FIG. 3 in the greater detail. Beginning in step 120, the system 10 creates a voxel grid for the uDF at a first resolution. The voxel grid has a first plurality of voxels. For example, as shown in FIG. 9 (which illustrates a multi-resolution iso-surface extraction for uDFs performed by the system 10 of the present disclosure), the system 10 creates a voxel grid having a first plurality of voxels 132 (e.g., squares) covering a surface 134 represented by multiple uDFs (e.g., a uDF(x₁) and a uDF(x₂) as examples). The surface 134 is simplified for illustration. It should be understood that the surface 134 can be 2D or 3D surface having arbitrary and open shapes.

In step 122, the system 10 hierarchically divides the voxel grid into a selected group of voxels and non-selected group of voxels. The selected group of voxels has a resolution higher than the first resolution. The non-selected group of voxels has the first resolution. For example, as shown in FIG. 9, the system 10 selects a first group of voxels 136 (e.g., voxels marked by “√”) from the first plurality of voxels 132 as a first subdivision 140 based at least in part on that at least one corner of each voxel of the first group of voxels 136 has a predicted closest unsigned distance (e.g., uDF(x₁) or the uDF(x₂) less than an edge length (e.g., h₀) of a voxel of the first plurality of voxels 132). The first group of voxels 136 are more proximity to the surface 134 than non-selected voxels 138 (e.g., voxels marked by “x”) of the first plurality of voxels 132. The system 10 can increase a resolution of the subdivision 140 to a second resolution (e.g., a smaller voxel size) higher than the first resolution. The first subdivision 140 at the second resolution has a second plurality of voxels 142 greater than the first group of voxels 136. The system 10 selects a second group of voxels 144 (e.g. voxels marked by “√”) from the second plurality of voxels 142 as a second subdivision 150 based at least in part on that at least one corner of each voxel of the second group of voxels 144 has a predicted closest unsigned distance less than an edge length (e.g., h₁) of a voxel of the second plurality of voxels 142. The second group of voxels 144 are more proximity to the 3D surface than non-selected voxels 146 (e.g., voxels marked by “x”) and the first group of voxels 136. The non-selected voxles 138 maintains the first resolution.

In step 124, the system 10 converts the selected group of voxels into a mesh using marching cubes. For example, as shown in FIG. 9, the system 10 converted the selected group of voxels 144 (e.g. voxels marked by “√”) into mesh 170 via marching cubes 160 that can extract a polygonal mesh of an iso-surface from a three-dimensional discrete scalar field (e.g., voxels). In step 126, the system 10 extracts iso-surface of the 3D representation based at least in part on the mesh. For example, the system 10 can extract an iso-surface that represents points of a constant value (also referred to iso-values), which can be determined by a user or the system 10.

Referring back to FIG. 3, in some embodiments, in step 58B, the system 10 renders a view of the 3D representation. In some embodiments, a sphere tracing uDFs is used to render images from a distance field that represents the shape. To create an image, rays are cast from the focal point of the camera, and their intersection with the scene is computed using sphere tracing uDFs. Roughly speaking, irradiance/radiance computations are performed at the point of intersection to obtain the color of the pixel for that ray. For example, FIG. 10 is a flowchart illustrating the step 58B of FIG. 3 in the greater detail. Beginning in step 200, the system 10 casts a plurality of rays from a viewpoint. For example, the system 10 casts a plurality of rays from a focal point of the camera.

In step 202, the system 10 processes each ray using a novel sphere tracing to determine intersections of each ray and the 3D surface based at least in part on an unsigned distance field associated points along a ray direction of each ray and a normal vector field associated with stop points where iterative marching of the sphere tracing of each ray stops. In some embodiments, the system 10 processes each ray originating at a first point using an iterative marching to obtain a second point using a step size of a predicted closest unsigned distance to the 3D surface from the first point along the ray direction.

For example, as shown in FIG. 11 (which illustrates a graph 210 showing a sphere tracing procedure and a graph 220 leveraging a nVF for obtaining more accurate ray-scene intersections performed by the system 10 of the present disclosure), given a ray, r, originating at point, p₀, iterative marching along the ray is performed to obtain its intersection with the surface. In the first iteration, this translates to taking a step along the ray with a step size of uDF(p₀) to obtain the next point p₁=p₀+r*uDF(p₀). Since uDF(p₀) is the smallest distance to the surface, the line segment [p₀, p₁] of the ray r does not intersect the surface (p₁ can touch but not transcend the surface). The above step is iterated i times till pᵢ is ∈ close to the surface. The i-th iteration is given by pᵢ=pᵢ₋₁+uDF(pᵢ) and the stopping criteria uDF(pi)≤∈.

The system 10 can further determine that the iterative marching stops at a stop point for each ray. The stop point is close to the 3D surface. For example, as shown in FIG. 11, the iterative marching stops at the point pᵢ 212.

The system 10 can further estimates an intersection of each ray and the 3D surface based at least in part on an angle between a predicted normal vector to the 3D surface closest to the stop point and the ray direction. In some embodiments, if the ray is close enough to the surface, the system 10 can use a local planarity assumption (without loss of generalization) to obtain the intersection estimate. For example, as shown in the graph 220 of FIG. 11, if the sphere tracing of the uDF stops at a point pᵢ, the system 10 evaluates the nVF as n=nVF(pᵢ), and computes a cosine of an angle θ between the nVF (e.g., n=f_{θ}_{ₙ}(pᵢ)) and the ray direction r. An estimated intersection 222 is then obtained as pₚᵣₒⱼ=pᵢ+r*uDF(pᵢ)/(r·n).

In step 204, the system 10 renders a view of the 3D surface representation based at least in part on the determined intersections. For example, the system 10 renders a view of the 3D surface representation using at least the estimated intersection 222.

Referring back to FIG. 3, in some embodiments, in step 58C, the system 10 evaluates the 3D representation. For example, the system 10 uses several metrics for evaluation, such as a depth error, a normal map error, an IOU error. The system 10 can evaluate a mean absolute error (MAE) between a ground truth depth map and an estimated depth map which can obtained by sphere tracing the learned 3D representation. This error is evaluated only on the “valid” pixels, which the system 10 defines to be the pixels which have non-infinite depth in both the ground truth and estimated depth map. This metric captures the accuracy of ray-isosurface intersection. The system 10 can evaluate a normal map error. Similarly, the system 10 can evaluate the L2 distance between the sphere-traced normal map and the ground truth normal map for the valid pixels. Since the surface normals play a vital role in rendering, this metric is informative of the fidelity of the final render. Regarding the IOU, since both depth error and normal map error are evaluated only on the valid pixels, they do not quantify whether the geometry of the final shape is correct. Therefore, the system 10 also evaluates Pixel IOU, which is defined as,

$$IOU = \frac{\# Valid Pixels}{\# Invalid Pixels + \# Valid Pixels} \qquad Equation ( 6 )$$

Here the Invalid pixels are those which have non-infinite depth in either the ground truth depth map or the estimated depth map but not both.

The system 10 also compares the determined 3D representation with 3D representations generated by the SAL and the DeepSDF. The system 10 evaluates on three challenging shapes. First the system 10 chooses the Bathtub (B), which has high fidelity details. Second, the system 10 selects the Split Sphere (S), to analyze how well the 3D representation disclosed herein can model the gap between the spheres. Finally, the system 10 evaluates on Intersecting Planes (IP), a triangle soup with complex topology.

In some embodiments, to generate the 3D representations for the shapes B, S, and IP, the system 10 can start off with a triangle soup normalized between [−0.5, 0.5], and densely sample 250,000 points on the faces of the triangles. For each of these points, the associated normal for training the nVF is the normal of the face from which it is sampled from. The system 10 can randomly perturb these 250,000 points along the xyz axes using the same strategy followed in the DeepSDF. For each of these 25,0000 points, the system 10 can find the nearest point in the unperturbed set of points, and compute the distance between them. These distances are used to train the uDF. Additionally, the system 10 can also sample 25,000 points uniformly in the space, and follow the same procedure for creating the ground truth. Finally, the system 10 can use 90% of this data for training and 10% for validation and train DUDE using these samples. For both f_{θ}_{_{d}} and f_{θ}_{ₙ}, the system 10 can use a 6 layer MLP with rectified linear unit (ReLU) activations and 512 hidden units in each layer. An optimizer (e.g., Adam optimizer) is used with le-4 learning rate. Note, for training the DeepSDF, the system 10 can first convert the mesh to watertight using the existing procedure before sampling points in the space.

FIG. 12 illustrates visualizations 250 of implicit 3D shape representations learned on three shapes. While the DeepSDF system learns over-smoothed representations (top row) owing to the intermediate watertighting step, the SAL system learns to close out regions which are intended to be open (middle row). Additionally, both the DeepSDF and the SAL systems have poor surface normal estimates on open surfaces (middle row) and complex topology (bottom row). In contrast, the DUDE system learns high fidelity shape representations while at the same time generating visually pleasing renderings on complex shapes owing to the high quality normals estimated by a separately learned nVF. For the Bathtub model, a loss in fidelity is observed due to the watertighting process. The SAL seems to retain some of the details, but the normal estimation fails, leading to low quality rendering. For the Split Sphere, no loss is fidelity is recorded owing to the simplicity of the shape, but the watertighting process distorts the geometry to cause inconsistent surface normals. This is primarily the reason why the renderings from the DeepSDF do not look visually good. On the other hand, the SAL appears to close out the split sphere. However, the DUDE system obtains visually good results, owing to high quality surface normals obtained from the learned nVF. A similar trend follows for the Intersecting Planes model. It is clearly shown that learning a separate nVF is needed to obtain precise surface normal in addition to the learned distance fields near the surface.

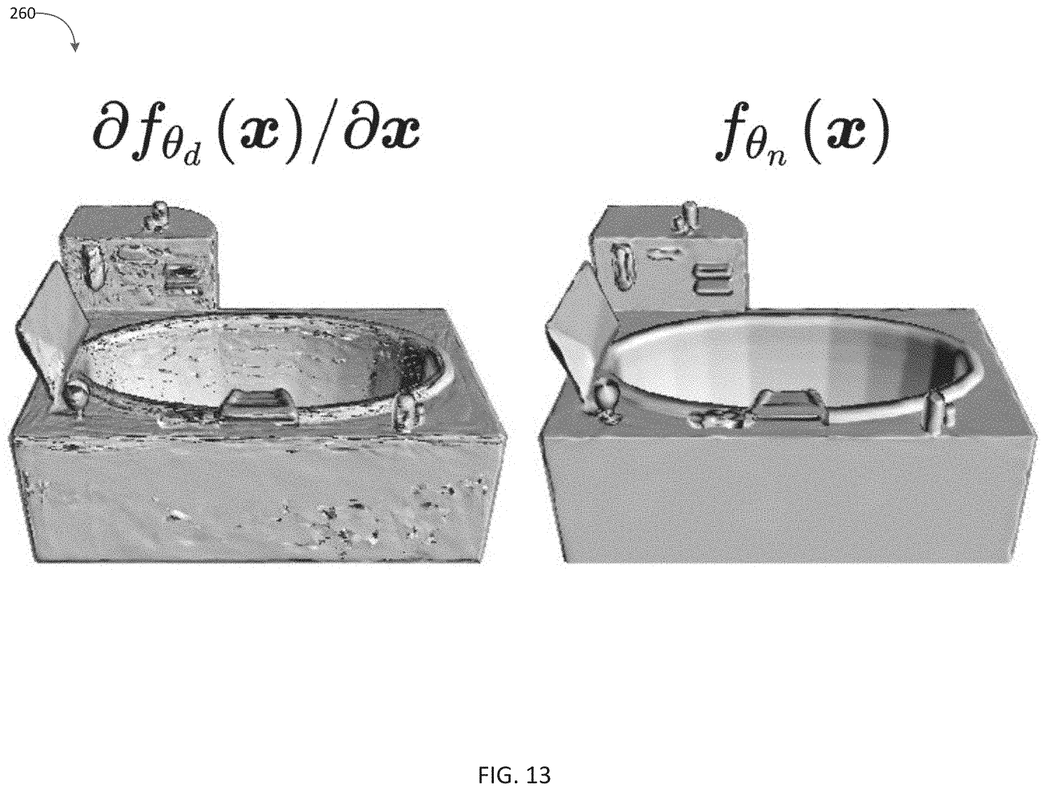

FIG. 13 illustrates a ray casting using normals obtained by differentiating the uDF on the left and a ray casting using the surface normals estimated by the nVF on the right. As shown in FIG. 13, this high-quality rendering validates the need for learning an nVF alongside a uDF.

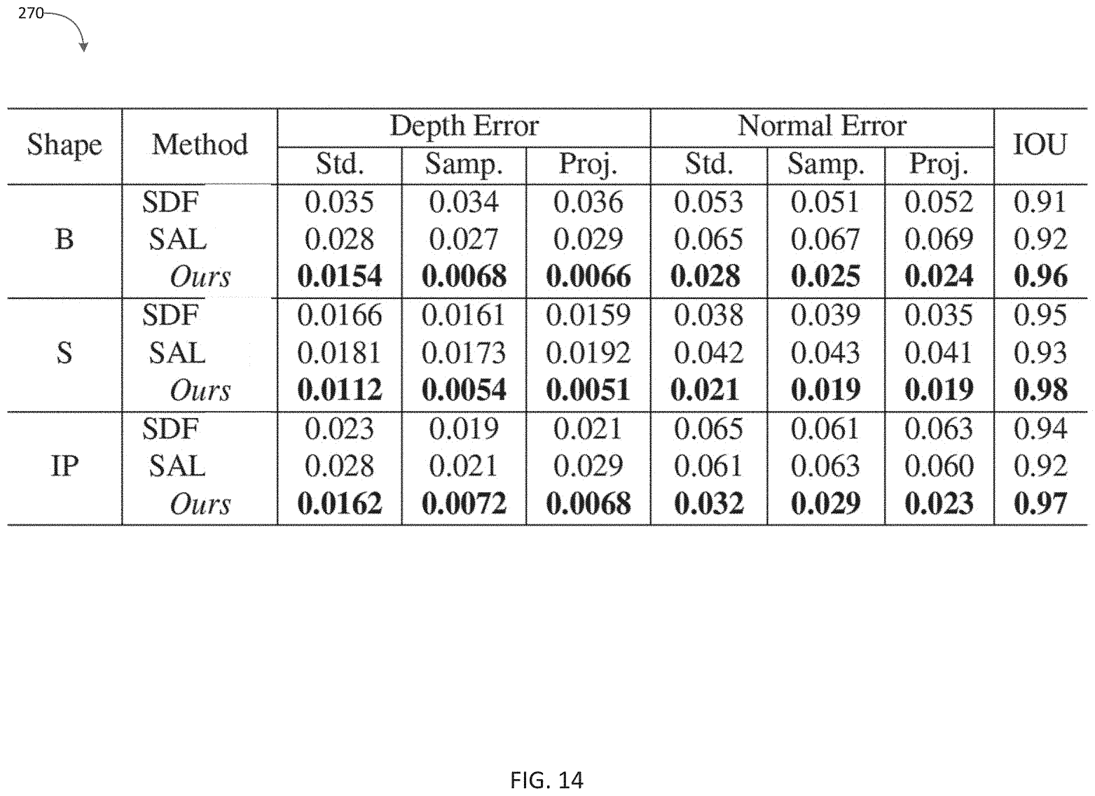

FIG. 14 is a quantitative comparison 270 of depth error, normal error, and silhouette IOU metrics described above. The system 10 evaluates the metrics as described above on original (non-watertight) mesh. For the bathtub mesh (B), the depth error of DUDE is higher when compared to the other two methods. Similarly, for the Split Sphere (S), that SAL performs the worst, as it has a tendency to fill up gaps. Additionally, on the Intersecting Planes (IP), the SAL is marginally worse than DeepSDF.

In some embodiments, to evaluate the sphere tracing of the present disclosure, the system 10 can use two baselines for sphere tracing. First, the system 10 can use a “Standard” method that terminates the sphere tracing process on reaching a certain threshold. Second, after stopping the sphere tracing at a certain threshold, the system 10 can resample the learned uDF at 100 points along the direction of the ray in the vicinity of the point where the system 10 stopped the sphere tracing. More concretely, the system 10 can stop the tracing process at pᵢ=pᵢ₋₁+uDF(pᵢ), and select a set of points [symbol] ={pᵢ+λr}, by choosing 100 values of λ's uniformly in the range [−0.01, +0.01]. The point of intersection is given by

$${}_{p ϵ 𝒫}^{argmin}{f}{}_{{θ}_{d}}^{} ( p ) .$$

The second method is called “Resample” which takes 100× more time than the standard method. The sphere tracing of the present disclosure is called “Projection.” In FIG. 14, as described above, it can be seen that the “Projection” method outperforms the “Standard” method, and performs marginally better than the “Resample” method which takes 100× more computation than the “Projection” method. In some cases, the normal estimates are also improved as a result of the improved intersection computation.

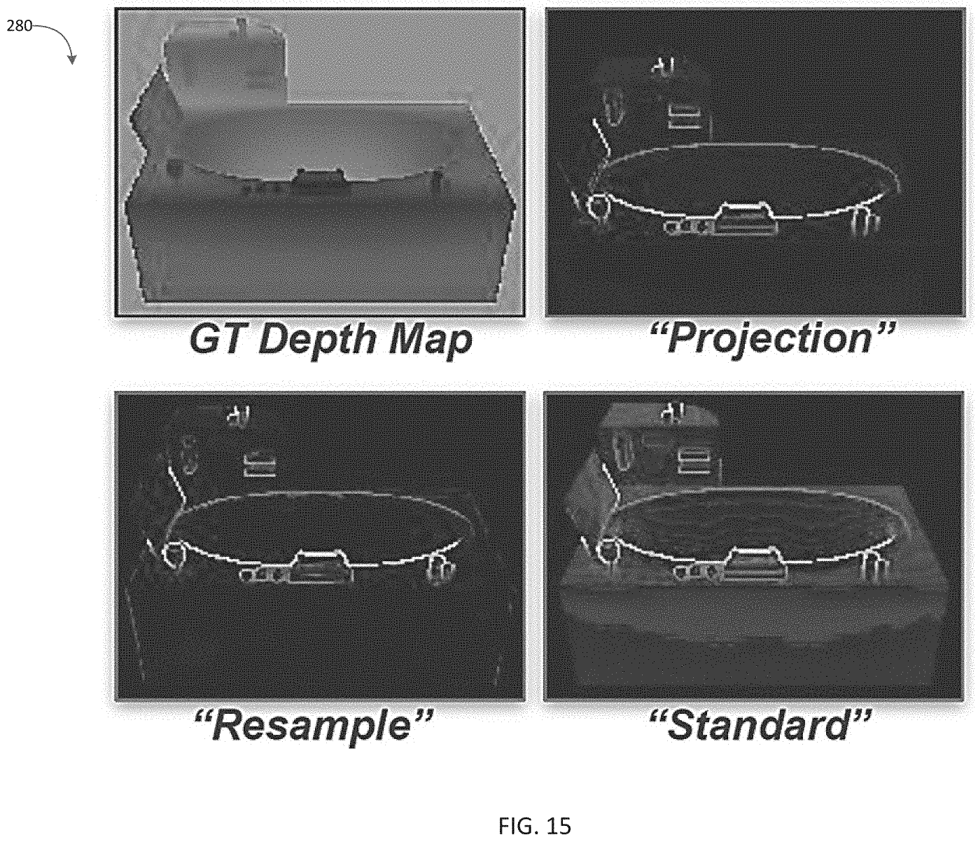

FIG. 15 illustrates graphs 280 showing absolute depth error between ground truth depth map and depth map estimated using a sphere tracing of the present disclosure and other systems. The depth error maps show that the “Projection” method performs better qualitatively. The “Resample” method uses 100× more compute than the proposed “Projection” method, but still has marginally higher error.

In some embodiments, the system 10 can not only process a triangle soup, but also can process the point clouds to generate 3D representation using a uDF and a nVF. For example, the system 10 can use the following learning functions,

f_{θ}_{_{d}}(zᵢ,x)≈uDFᵢ(x), and

f_{θ}_{ₙ}(zᵢ,x)≈uVFᵢ(x) Equation (7)

Here, zᵢ is the encoding of the sparse point cloud of the shape. Once trained on a set of training point clouds, the system 10 can evaluate the functions on unseen point clouds, and reconstruct the surface.

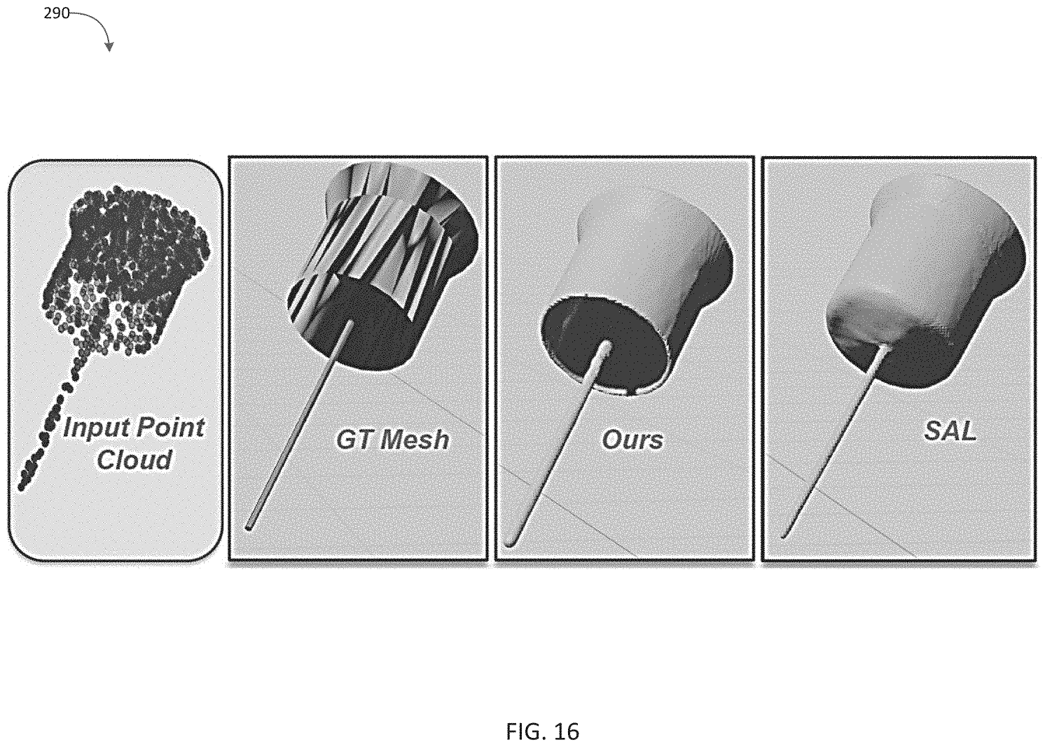

FIG. 16 illustrates results 290 on surface reconstruction from point clouds. A subset of models from the lamp class of ShapeNet is used to train both the DUDE system and the SAL system. The SAL system closes out the bottom of the lamp, whereas the DUDE system correctly models the gap. Additionally, the DUDE system obtains a mean chamfer distance of 1.67e-3 as opposed to SAL system which obtains 1.84e-3. This clearly demonstrates the superiority of the DUDE system in representing open shapes.

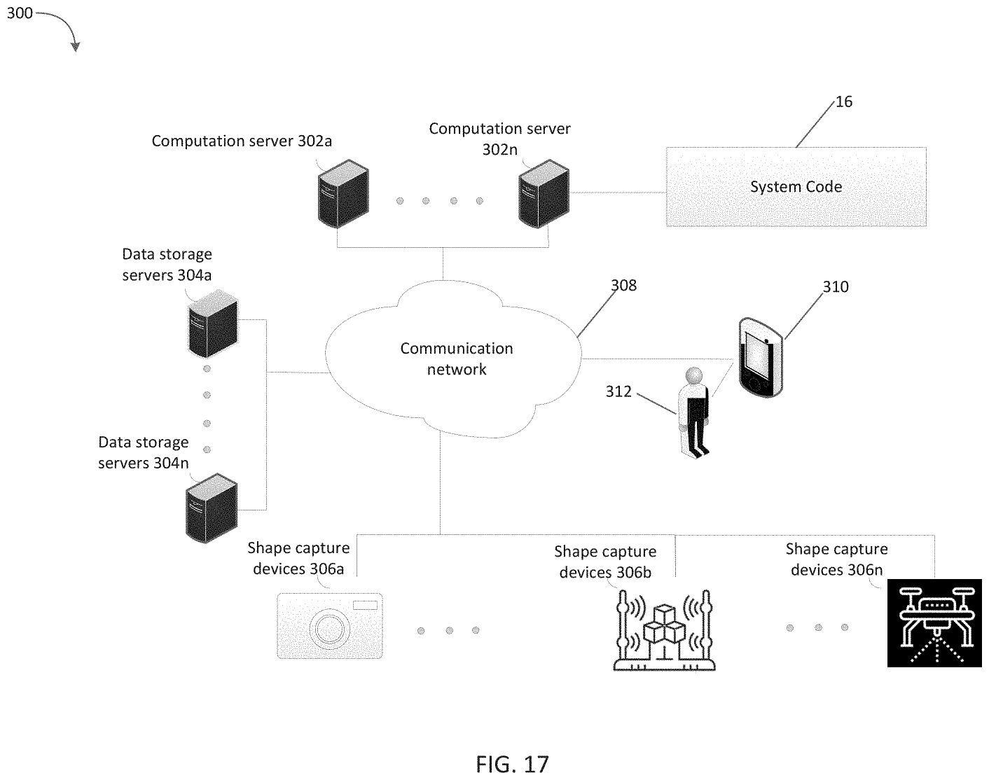

FIG. 17 is a diagram illustrating computer hardware and network components on which the system 300 can be implemented. The system 300 can include a plurality of computation servers 302a-302n having at least one processor (e.g., one or more graphics processing units (GPUs), microprocessors, central processing units (CPUs), etc.) and memory for executing the computer instructions and methods described above (which can be embodied as system code 16). The system 300 can also include a plurality of data storage servers 304a-304n for receiving 2D/3D data associated with one or more objects. The system 300 can also include a plurality of shape capture devices 306a-306n for capturing shape data. For example, the shape capture devices can include, but are not limited to, a digital camera 306a, a 3D scanner 306b, and an unmanned aerial vehicle 306a for capturing 2D/3D objects. A user device 310 can include, but it not limited to, a laptop, a smart telephone, and a tablet to display a 3D representation to a user 312, and/or to provide feedback for fine-tuning the models. The computation servers 302a-302n, the data storage servers 304a-304n, the shape capture devices 306a-306n, and the user device 310 can communicate over a communication network 308. Of course, the system 300 need not be implemented on multiple devices, and indeed, the system 300 can be implemented on a single (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by

Letters Patent is set forth in the following claims:

1. A computer vision system for generating a three-dimensional (3D) surface representation, comprising:
a memory; and
a processor in communication with the memory, the processor:
receiving data associated with the 3D surface;
processing the data based at least in part on one or more computer vision models to predict an unsigned distance field and a normal vector field, the unsigned distance field indicative of a proximity to the 3D surface, the normal vector field indicative of a surface orientation of the 3D surface, wherein the unsigned distance field comprises a predicted closest unsigned distance to a surface point of the 3D surface from a given point in a 3D space, and the normal vector field comprises a predicted normal vector to the surface point closest to the given point; and
determining the 3D surface representation based at least in part on the unsigned distance field and the normal vector field.

2. The system of claim 1, wherein the data comprises one or more open shapes with arbitrary topology.

3. The system of claim 1, wherein the data comprises a triangle soup having a plurality of triangles.

4. The system of claim 1, wherein the data comprises a plurality of point clouds.

5. The system of claim 1, wherein the processor further performs the steps of:
creating a voxel grid for the unsigned distance field at a first resolution, the voxel grid having a first plurality of voxels;
hierarchically dividing the voxel grid into a selected group of voxels and non-selected group of voxels, the selected group of voxels having a resolution higher than the first resolution, the non-selected group of voxels having the first resolution;
converting the selected group of voxels into a mesh using marching cubes; and
extracting iso-surface of the 3D representation based at least in part on the mesh.

6. The system of claim 5, wherein the processor hierarchically divides the voxel grid by:
selecting a first group of voxels from the first plurality of voxels as a first subdivision based at least in part on that at least one corner of each voxel of the first group of voxels has a predicted closest unsigned distance less than an edge length of a voxel of the voxel grid, the first group of voxels being more proximity to the 3D surface than non-selected voxels of the first plurality of voxels;
increasing a resolution of the first subdivision to a second resolution higher than the first resolution, the first subdivision having a second plurality of voxels, the number of the second plurality of voxels being greater than the first group of voxels; and
selecting a second group of voxels from the second plurality of voxels as a second subdivision based at least in part on that at least one corner of each voxel of the second group of voxels has a predicted closest unsigned distance less than an edge length of a voxel of the first subdivision, the second group of voxels being more proximity to the 3D surface than the first group of voxels,
wherein the second group of voxels comprise the selected group of voxels.

7. The system of claim 1, wherein the processor further performs the steps of:
casting a plurality of rays from a viewpoint;
processing each ray using sphere tracing to determine intersections of each ray and the 3D surface based at least in part on an unsigned distance field associated points along a ray direction of each ray and a normal vector field associated with stop points where iterative marching of the sphere tracing of each ray stops; and
rendering a view of the 3D surface representation based at least in part on the determined intersections.

8. The system of claim 7, wherein the processor processes each ray using the sphere tracing by:
processing each ray originating at a first point using the iterative marching to obtain a second point using a step size of a predicted closest unsigned distance to the 3D surface from the first point along the ray direction;
determining that the iterative marching stops at a stop point for each ray, the stop point is close to the 3D surface;
estimating an intersection of each ray and the 3D surface based at least in part on an angle between a predicted normal vector to the 3D surface closest to the stop point and the ray direction,
wherein the determined intersections comprise the estimated intersection.

9. The system of claim 1, wherein the processor further trains the one or more computer vision models by:
sampling a set of training pairs from a given 3D shape represented by a noisy triangle soup, each training pair comprising a sampling surface point on a triangle face and a surface normal from the sampling surface point;
constructing a set of training samples, each training sample comprising a sampling point in the 3D space, a ground truth distance, and a ground truth surface normal, wherein the ground truth distance is a distance between the sampling point and a nearest corresponding surface point in a training pair of the set of training pairs, and the ground truth surface normal is a surface normal from the training pair;
estimating, using the one or more computer vision models, an unsigned distance associated with each training sample;
estimating, using the one or more computer vision models, a normal vector associated with each training sample;
determining a first loss between the estimated unsigned distance and the ground truth distance;
determining a second loss between the estimated normal vector and the ground truth surface normal; and
training the one or more computer vision models based at least in part on minimizing the first loss and the second loss.

10. The system of claim 9, wherein the second loss is selected from a loss between the estimated normal vector and a first ground truth surface normal and a loss between the estimated normal vector and a second ground truth surface normal, the second ground truth surface normal indicative of a modulo 180° of the first ground truth surface normal, wherein the ground truth surface normal comprises the first ground truth surface normal and the second surface normal.

11. A computer vision method for generating a three-dimensional (3D) surface representation, comprising the steps of:
receiving data associated with the 3D surface;
processing the data based at least in part on one or more computer vision models to predict an unsigned distance field and a normal vector field, the unsigned distance field indicative of proximity to the 3D surface, the normal vector field indicative of a surface orientation of the 3D surface, wherein the unsigned distance field comprises a predicted closest unsigned distance to a surface point of the 3D surface from a given point in a 3D space, and the normal vector field comprises a predicted normal vector to the surface point closest to the given point; and
determining the 3D surface representation based at least in part on the unsigned distance field and the normal vector field.

12. The method of claim 11, wherein the data comprises one or more open shapes with arbitrary topology.

13. The method of claim 11, wherein the data comprises a triangle soup having a plurality of triangles.

14. The method of claim 11, wherein the data comprises a plurality of point clouds.

15. The method of claim 11, further comprising:
creating a voxel grid for the unsigned distance field at a first resolution, the voxel grid having a first plurality of voxels;
hierarchically dividing the voxel grid into a selected group of voxels and non-selected group of voxels, the selected group of voxels having a resolution higher than the first resolution, the non-selected group of voxels having the first resolution;
converting the selected group of voxels into a mesh using marching cubes; and
extracting iso-surface of the 3D representation based at least in part on the mesh.

16. The method of claim 15, wherein the step of hierarchically dividing the voxel grid comprises:
selecting a first group of voxels from the first plurality of voxels as a first subdivision based at least in part on that at least one corner of each voxel of the first group of voxels has a predicted closest unsigned distance less than an edge length of a voxel of the voxel grid, the first group of voxels being more proximity to the 3D surface than non-selected voxels of the first plurality of voxels;
increasing a resolution of the first subdivision to a second resolution higher than the first resolution, the first subdivision having a second plurality of voxels, the number of the second plurality of voxels being greater than the first group of voxels; and
selecting a second group of voxels from the second plurality of voxels as a second subdivision based at least in part on that at least one corner of each voxel of the second group of voxels has a predicted closest unsigned distance less than an edge length of a voxel of the first subdivision, the second group of voxels being more proximity to the 3D surface than the first group of voxels,
wherein the second group of voxels comprise the selected group of voxels.

17. The method of claim 11, further comprising:
casting a plurality of rays from a viewpoint;
processing each ray using sphere tracing to determine intersections of each ray and the 3D surface based at least in part on an unsigned distance field associated points along a ray direction of each ray and a normal vector field associated with stop points where iterative marching of the sphere tracing of each ray stops; and
rendering a view of the 3D surface representation based at least in part on the determined intersections.

18. The method of claim 17, wherein the step of processing each ray using the sphere tracing comprises:
processing each ray originating at a first point using the iterative marching to obtain a second point using a step size of a predicted closest unsigned distance to the 3D surface from the first point along the ray direction;
determining that the iterative marching stops at a stop point for each ray, the stop point is close to the 3D surface;
estimating an intersection of each ray and the 3D surface based at least in part on an angle between a predicted normal vector to the 3D surface closest to the stop point and the ray direction,
wherein the determined intersections comprise the estimated intersection.

19. The method of claim 18, further comprising training the one or more computer vision models, wherein the step of training the one or more computer vision comprises:
sampling a set of training pairs from a given 3D shape represented by a noisy triangle soup, each training pair comprising a sampling surface point on a triangle face and a surface normal from the sampling surface point;
constructing a set of training samples, each training sample comprising a sampling point in the 3D space, a ground truth distance, and a ground truth surface normal, wherein the ground truth distance is a distance between the sampling point and a nearest corresponding surface point in a training pair of the set of training pairs, and the ground truth surface normal is a surface normal from the training pair;
estimating, using the one or more computer vision models, an unsigned distance associated with each training sample;
estimating, using the one or more computer vision models, a normal vector associated with each training sample;
determining a first loss between the estimated unsigned distance and the ground truth distance;
determining a second loss between the estimated normal vector and the ground truth surface normal; and
training the one or more computer vision models based at least in part on minimizing the first loss and the second loss.

20. The method of claim 19, wherein the second loss is selected from a loss between the estimated normal vector and a first ground truth surface normal and a loss between the estimated normal vector and a second ground truth surface normal, the second ground truth surface normal indicative of a modulo 180° of the first ground truth surface normal, wherein the ground truth surface normal comprises the first ground truth surface normal and the second surface normal.

21. A non-transitory computer readable medium having instructions stored thereon for a three-dimensional (3D) surface representation which, when executed by a processor, causes the processor to carry out the steps of:
receiving data associated with the 3D surface;
processing the data based at least in part on one or more computer vision models to predict an unsigned distance field and a normal vector field, the unsigned distance field indicative of proximity to the 3D surface, the normal vector field indicative of a surface orientation of the 3D surface, wherein the unsigned distance field comprises a predicted closest unsigned distance to a surface point of the 3D surface from a given point in a 3D space, and the normal vector field comprises a predicted normal vector to the surface point closest to the given point; and
determining the 3D surface representation based at least in part on the unsigned distance field and the normal vector field.

22. The non-transitory computer readable medium of claim 21, wherein the data comprises one or more open shapes with arbitrary topology.

23. The non-transitory computer readable medium of claim 21, wherein the data comprises a triangle soup having a plurality of triangles.

24. The non-transitory computer readable medium of claim 21, wherein the data comprises a plurality of point clouds.

25. The non-transitory computer readable medium of claim 21, further comprising:
creating a voxel grid for the unsigned distance field at a first resolution, the voxel grid having a first plurality of voxels;
hierarchically dividing the voxel grid into a selected group of voxels and non-selected group of voxels, the selected group of voxels having a resolution higher than the first resolution, the non-selected group of voxels having the first resolution;
converting the selected group of voxels into a mesh using marching cubes; and
extracting iso-surface of the 3D representation based at least in part on the mesh.

26. The non-transitory computer readable medium of claim 25, wherein the step of hierarchically dividing the voxel grid comprises:
selecting a first group of voxels from the first plurality of voxels as a first subdivision based at least in part on that at least one corner of each voxel of the first group of voxels has a predicted closest unsigned distance less than an edge length of a voxel of the voxel grid, the first group of voxels being more proximity to the 3D surface than non-selected voxels of the first plurality of voxels;
increasing a resolution of the first subdivision to a second resolution higher than the first resolution, the first subdivision having a second plurality of voxels, the number of the second plurality of voxels being greater than the first group of voxels; and
selecting a second group of voxels from the second plurality of voxels as a second subdivision based at least in part on that at least one corner of each voxel of the second group of voxels has a predicted closest unsigned distance less than an edge length of a voxel of the first subdivision, the second group of voxels being more proximity to the 3D surface than the first group of voxels,
wherein the second group of voxels comprise the selected group of voxels.

27. The non-transitory computer readable medium of claim 21, further comprising:
casting a plurality of rays from a viewpoint;
processing each ray using sphere tracing to determine intersections of each ray and the 3D surface based at least in part on an unsigned distance field associated points along a ray direction of each ray and a normal vector field associated with stop points where iterative marching of the sphere tracing of each ray stops; and
rendering a view of the 3D surface representation based at least in part on the determined intersections.

28. The non-transitory computer readable medium of claim 27, wherein the step of processing each ray using the sphere tracing comprises:
processing each ray originating at a first point using the iterative marching to obtain a second point using a step size of a predicted closest unsigned distance to the 3D surface from the first point along the ray direction;
determining that the iterative marching stops at a stop point for each ray, the stop point is close to the 3D surface;
estimating an intersection of each ray and the 3D surface based at least in part on an angle between a predicted normal vector to the 3D surface closest to the stop point and the ray direction,
wherein the determined intersections comprise the estimated intersection.

29. The non-transitory computer readable medium of claim 28, further comprising training the one or more computer vision models, wherein the step of training the one or more computer vision comprises:
sampling a set of training pairs from a given 3D shape represented by a noisy triangle soup, each training pair comprising a sampling surface point on a triangle face and a surface normal from the sampling surface point;
constructing a set of training samples, each training sample comprising a sampling point in the 3D space, a ground truth distance, and a ground truth surface normal, wherein the ground truth distance is a distance between the sampling point and a nearest corresponding surface point in a training pair of the set of training pairs, and the ground truth surface normal is a surface normal from the training pair;
estimating, using the one or more computer vision models, an unsigned distance associated with each training sample;
estimating, using the one or more computer vision models, a normal vector associated with each training sample;
determining a first loss between the estimated unsigned distance and the ground truth distance;
determining a second loss between the estimated normal vector and the ground truth surface normal; and
training the one or more computer vision models based at least in part on minimizing the first loss and the second loss.

30. The non-transitory computer readable medium of claim 29, wherein the second loss is selected from a loss between the estimated normal vector and a first ground truth surface normal and a loss between the estimated normal vector and a second ground truth surface normal, the second ground truth surface normal indicative of a modulo 180° of the first ground truth surface normal, wherein the ground truth surface normal comprises the first ground truth surface normal and the second surface normal.
